(19) United States
(12) Patent Application Publication
(10) Pub. No.: US 2026/0217097 A1
(43) Pub. Date: Jul. 30, 2026

(54) WEATHERSTRIP

(71) Applicants: NISHIKAWA RUBBER CO., LTD., Hiroshima (JP); HONDA MOTOR CO., LTD., Tokyo (JP)

(72) Inventors: Akiyoshi KUBOTA, Hiroshima (JP); Atsushi NAKASHIMA, Tokyo (JP)

(21) Appl. No.: 19/447,508

(22) Filed: Jan. 13, 2026

(30) Foreign Application Priority Data
Jan. 30, 2025 (JP) 2025-013595

(51) Int. Cl. B60J 10/84; B60J 10/36

(52) U.S. Cl. CPC B60J 10/84; B60J 10/36

(57) ABSTRACT

A front weatherstrip includes: a front weatherstrip body configured to be disposed along a vehicle body; a baseplate integrally connected to the front weatherstrip body; a return plate having a part integrally connected to a back face of the baseplate and a remaining part extending along the back face, the return plates being completely covered with the baseplate when viewed from an outside face side of the baseplate; an outsert board which is a board formed from a material harder than the baseplate, the outsert board being inserted between the back face of the baseplate and the return plate to be completely covered with the baseplate when viewed from an outside face side of the baseplate; and an outsert clip disposed to rise on the outsert board, penetrating through a hole formed in the return plate, and configured to be fitted in a clip hole formed in the vehicle body.

### CROSS-REFERENCE TO RELATED APPLICATIONS

The present application is based on, and claims priority to Japanese Patent Application No. 2025-013595, filed January 30, 2025, the disclosure of which is incorporated herein by reference in its entirety.

### BACKGROUND

### Technical Field

The present disclosure relates to a weatherstrip of a vehicle.

### Related Art

A known weatherstrip that seals a gap between a vehicle body opening and a door of a vehicle is described in, for example, Japanese Laid-Open Patent Application No. 2015-189455 (Patent Literature 1). In Patent Literature 1, to attach the weatherstrip, which is soft, to a vehicle body (or a door), a hard outsert clip from outside is fitted outside the weatherstrip such that the hard outsert clip penetrates through the weatherstrip to be fitted in the vehicle body (or a door body).

Moreover, a structure described in, for example, Japanese Published Utility Model Application No. H5-001539 U (Patent Literature 2) is a so-called hidden clip structure including a clip covered with a weatherstrip.

Further, in a structure described in, for example, Japanese Laid-Open Patent Application No. 2004-042726 (Patent Literature 3), a weatherstrip is attached to a door frame or the like with a double-faced adhesive tape.

Furthermore, in a structure described in, for example, Japanese Laid-Open Patent Application No. 2021-142951 (Patent Literature 4), in order to attach a soft weatherstrip to a door of a vehicle, an insert panel is embedded in a die molded part of the weatherstrip to enhance stiffness, and a clip formed as a separate component penetrates the die molded part of the weatherstrip to be fitted in a door body.

In the structure described in Patent Literature 1, the outsert clip is exposed while the door of the vehicle is open, and an exterior with dull unevenness and/or different glossiness at the part of attachment of the outsert clip comes into the field of view of a passenger, and therefore, the structure has an unstylish appearance, and thus, there is room for improvement in the structure.

In particular, the problem of impairing the appearance is significant in the case of a weatherstrip that is used for a door of a vehicle without a window frame to seal a gap between a vehicle body and a door glass of the vehicle. The structure of the vehicle without the window frame is also called a hardtop structure or a sashless structure.

In the structure described in Patent Literature 2, a head of the hidden clip is not exposed also when a door of a vehicle is open, but there is the problem that support stiffness of the weatherstrip can be ensured unless a large number of hidden clips are used.

In the structure described in Patent Literature 3, a seal member is attached to the door frame or the like of a vehicle with the double-faced adhesive tape. Therefore, a clip is no longer required, so that the problem concerning the appearance is solved. However, release paper is peeled to accomplish adhesion of the seal member, and therefore, the release paper results in waste.

The structure described in Patent Literature 4 has the problem that while the door of the vehicle is open, a head of the clip is exposed, thereby impairing the appearance. Further, a structure has been known in which a clip formed as a separate component is integrated into an insert panel, which is then embedded in a die molded part. However, even this configuration cannot omit a die contacting projection (a projection abutting the die such that the position of the insert panel is not shifted by a pressure when a die molding material is injected after the insert panel is fixed in a die cavity) of the insert panel. Thus, the die contacting projection is inevitably exposed on an outside face of the die molded part after die molding, and therefore, the problem of impairing the appearance is still unsolved.

In view of the foregoing, it is an object of the present disclosure to provide a weatherstrip having a structure in which the weatherstrip is attached and fixed to a vehicle-body-side member, such as a vehicle body, a door, or a hood of a vehicle, the structure impairing no appearance at the position of attachment of the weatherstrip, having satisfactory support stiffness, and producing no waste, such as release paper.

### SUMMARY

For this purpose, a weatherstrip of an aspect of the present disclosure includes: a weatherstrip body configured to be disposed along a vehicle-body-side member of a vehicle; a baseplate integrally connected to the weatherstrip body; a return plate integrally connected to the baseplate and disposed on a back face of the baseplate; an outsert board which is a board formed from a material harder than the baseplate, the outsert board being inserted between the back face of the baseplate and the return plate to be covered with the baseplate when viewed from an outside face side of the baseplate; and an outsert clip disposed to rise on the outsert board, penetrating through a hole formed in the return plate, and configured to be fitted in a clip hole formed in the vehicle-body-side member.

With this aspect, the outsert board, which is a structure for attaching and fixing the baseplate to the vehicle-body-side member, is completely hidden and cannot be seen when viewed from the outside face side of the baseplate. This can make the appearance of the weatherstrip attached and fixed to the vehicle-body-side member good. Note that the vehicle-body-side member of the vehicle may be a vehicle body or a door.

The number of the return plate may be one, but a plurality of return plates are preferably provided. The number of the outsert clip may be one, but a plurality of outsert clips may be provided, and each of the plurality of outsert clips may penetrate a corresponding one of the return plates. In an aspect of the present disclosure, the weatherstrip includes a plurality of the return plates, and the plurality of return plates each have a part integrally connected to an edge of the baseplate and a remaining part protruding toward a center of the baseplate to form a zone for housing the outsert board. With this aspect, the outsert board is housed with its three sides embraced by the plurality of return plates. Thus, the outsert board is reliably held by the baseplate. In another aspect, the number of return plate may be one or two.

In a preferable aspect of the present disclosure, the return plate has a lower edge part integrally connected to the back face of the baseplate and an upper edge part having the through hole. With this configuration, the baseplate is attached and fixed to a side surface of a vehicle-body-side member. Thus, the outsert board is suppressed from climbing over the return plate and falling down. In another aspect, the baseplate may be a front face or a rear face of the vehicle-body-side member.

In a further preferable aspect of the present disclosure, the lower edge part of the return plate is continuous with a thick plate part having a greater thickness than the upper edge part, and the outsert board has a cutoff for receiving the thick plate part. This aspect prevents the position of the outsert board held by the return plate from being shifted.

In an aspect of the present disclosure, the thick plate part may have a trapezoidal shape with a relatively short upper base and a relatively long lower base, and the cutoff of the outsert board may have a shape corresponding to the trapezoidal shape and may be fitted in the thick plate part. With this aspect, the outsert board is stably held by the thick plate part.

In an aspect of the present disclosure, the baseplate may have a longitudinal direction and a width direction, the outsert board may extend along the longitudinal direction of the baseplate, and a plurality of the return plates may be disposed with a space therebetween in the longitudinal direction of the baseplate. With this aspect, stiffness can be imparted to the baseplate in the longitudinal direction.

When the present disclosure includes a plurality of return plates, the plurality of return plates may include a return plate which no outsert clip penetrates, but the return plate is preferably fitted to the outsert board by using any fitting means. An aspect of the present disclosure may further include: a projection provided on the outsert board; and a hole which is formed in the return plate and in which the projection is fitted. With this aspect, the outsert board is reliably attached to the baseplate. Note that the hole may be a hole having no bottom, such as a through hole, or may be a bottomed hole.

In many cases, a decorative sheet for improving the appearance is attached and fixed to the outside face of the vehicle-body-side member. For example, a B-pillar garnish on an outside in the vehicle width direction is attached and fixed to a B-pillar (pillar of a vehicle interior center part) of the vehicle body, thereby improving the appearance of the B-pillar. In an aspect of the present disclosure, the baseplate may be a component that covers a fixing clip with which a decorative sheet is attached and fixed to the vehicle-body-side member, the plurality of return plates may be disposed while avoiding the fixing clip, and the outsert board may have an avoidance part for avoiding the fixing clip. With this aspect, an attachment and fixation structure of the decorative sheet and an attachment and fixation structure of the baseplate are collected in a compact manner, and the thickness thereof can be further reduced. In another aspect, the baseplate may be disposed not to cover and hide the fixing clip of the decorative sheet.

Thus, with the present disclosure, also when the door of the vehicle is open, the weatherstrip thus attached and fixed has a good appearance. Moreover, the outsert board is provided, and thereby, the stiffness at the attachment and fixation part is ensured.

### BRIEF DESCRIPTION OF THE DRAWINGS

FIG. 1A is a side view of a vehicle including a weatherstrip of an embodiment of the present disclosure;

FIG. 1B is a side view of a vehicle including a door weatherstrip of another embodiment of the present disclosure;

FIG. 1C is a side view of a vehicle including a vehicle-body-side weatherstrip of still another embodiment of the present disclosure;

FIG. 2 is an enlarged outside view of a baseplate of the embodiment;

FIG. 3 is an enlarged backside view of the baseplate of the embodiment;

FIG. 4 is a view of an outsert board taken out of the embodiment;

FIG. 5 is a sectional view taken along line V-V showing an attachment and fixation state of the embodiment;

FIG. 6 is a backside view of a positional relationship between the embodiment attached and fixed and a B-pillar garnish;

FIG. 7 is a sectional view taken along line VII- VII of FIG. 3; and

FIG. 8 is a sectional view taken along line VIII- VIII of FIG. 3.

### DETAILED DESCRIPTION

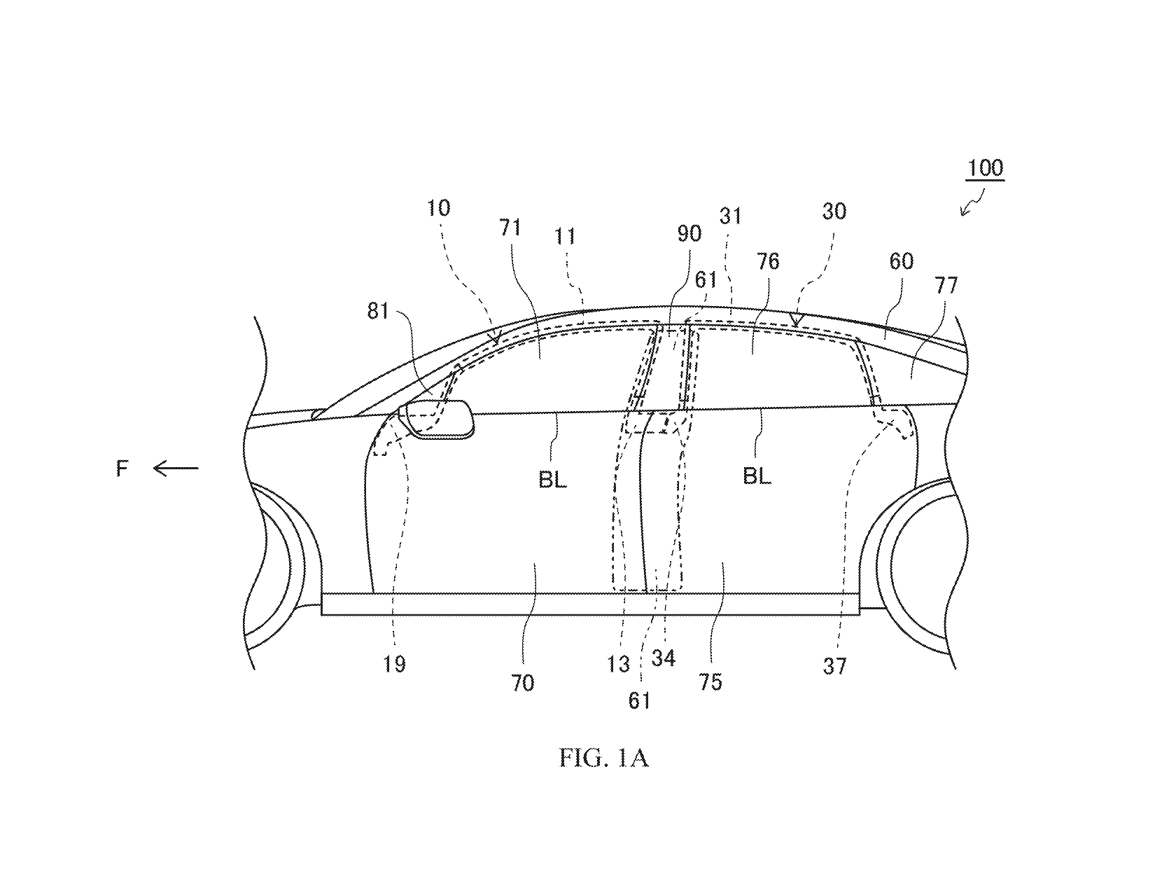

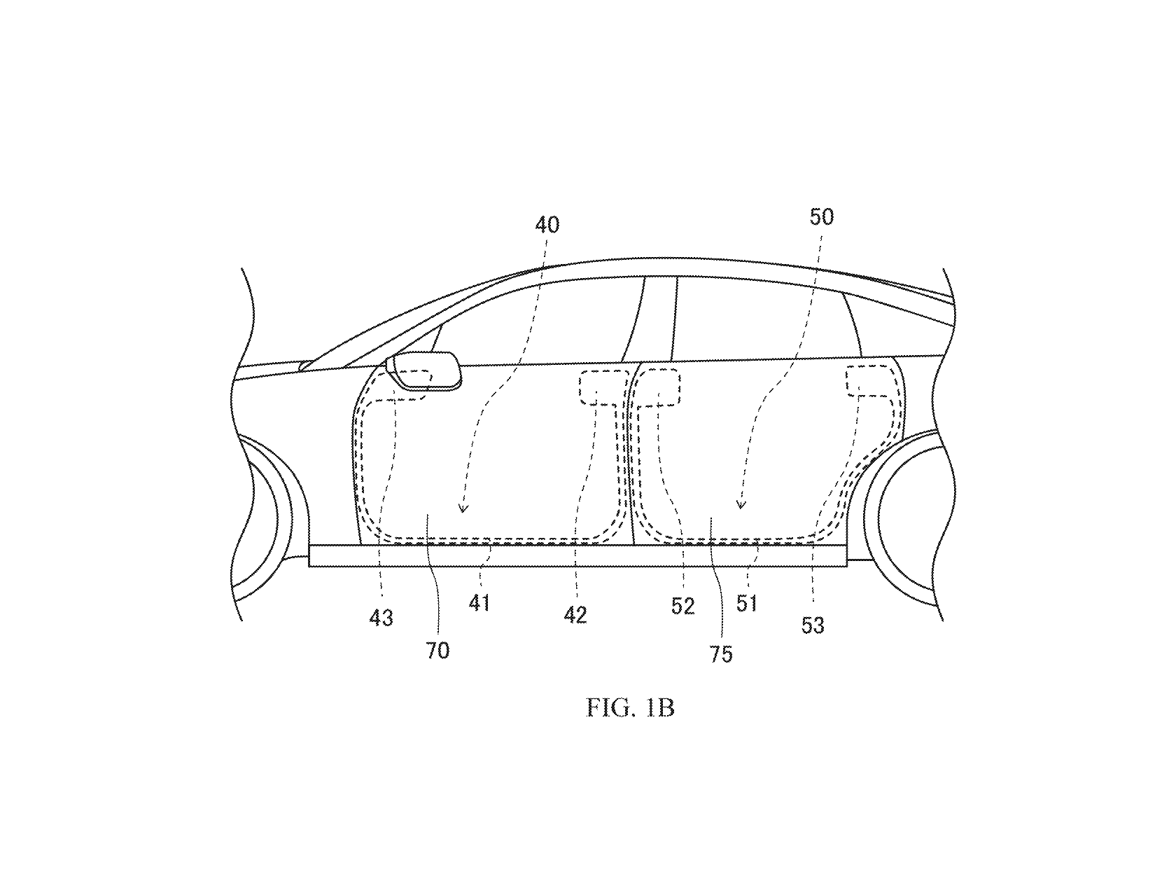

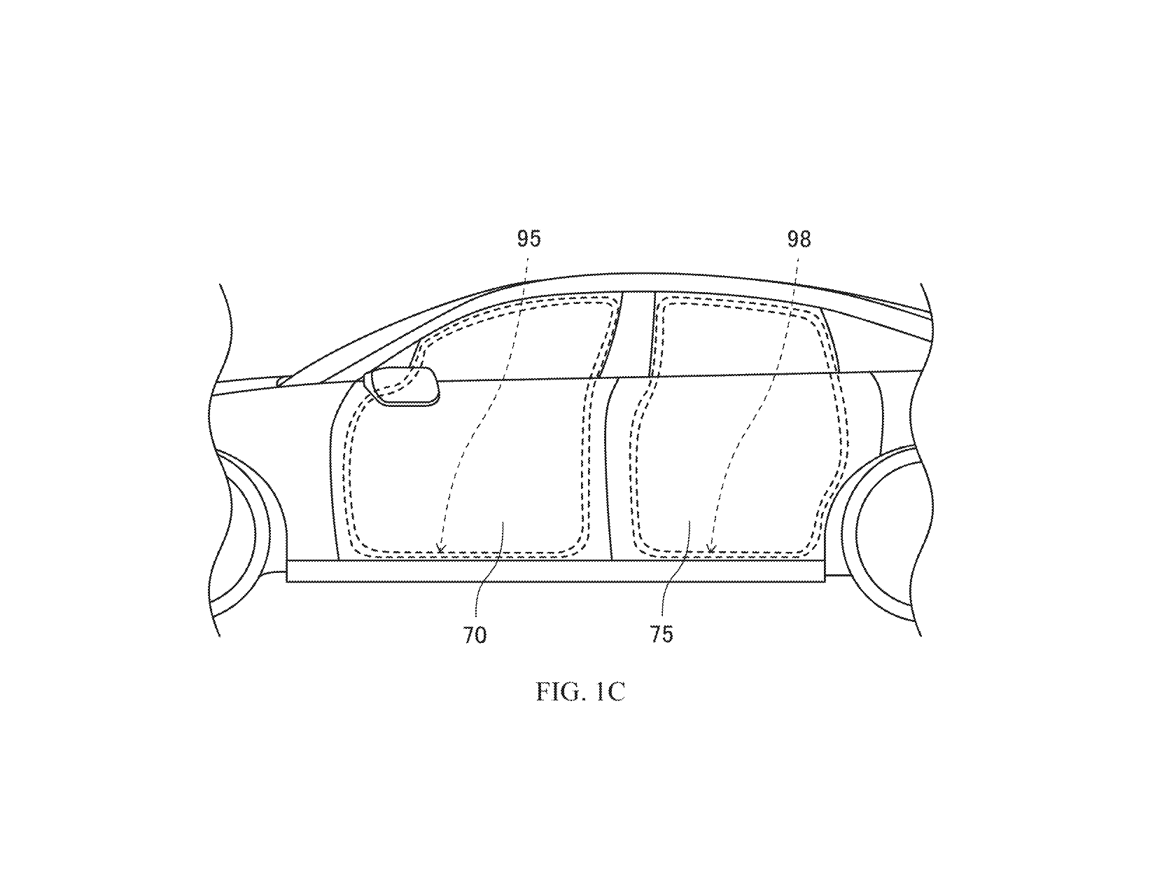

Embodiments of the present disclosure will be described in detail below with reference to the drawings. FIG. 1A is a side view of a vehicle (automobile) including a weatherstrip of an embodiment of the present disclosure, where this side view is a left side view in a forward direction of the vehicle. A vehicle 100 includes: a vehicle body 60 which defines a vehicle interior; and a front door 70 and a rear door 75 which open and close openings of the vehicle body 60. The same structure applies to the right side, facing away from the viewer in FIG. 1A, of the vehicle body 60. The front door 70 includes: an outer wall (door outer panel) made of metal and shown in FIG. 1A; and an inner wall (door inner panel) made of metal and not shown in the figure. The front door 70 supports a front door glass 71 between the outer wall and the inner wall. Moreover, the front door 70 can house the front door glass 71. The front door glass 71 slides in an up/down direction to cover a window opening at an upper position shown in FIG. 1A and to be housed in the front door 70 at a lower position not shown in the figure. The same structure applies to the rear door 75 and a rear door glass 76.

The vehicle 100 of the present embodiment has a hardtop or sashless structure. Therefore, the front door 70 and the rear door 75 each include no frame that define the window opening. Thus, a front edge, an upper edge, and a rear edge of each of the front door glass 71 and the rear door glass 76, except for a lower edge of the front door glass 71 and a lower edge of the rear door glass 76 respectively supported by the front door 70 and the rear door 75, are exposed at a proximity (FIG. 1A) to a belt line BL which is the upper position. Note that the front and the rear respectively refer to vehicle front and rear directions. In the drawings, the forward direction is accordingly denoted by reference symbol F.

When the front door 70 is in a closed position (FIG. 1A), the front door glass 71 directly covers the vehicle body 60. Therefore, a front weatherstrip 10 is attached and fixed to the vehicle body 60. The front weatherstrip 10 comes into elastic contact with the front door glass 71 to fill and seal a gap between the front door glass 71 and the vehicle body 60. In the same way, a rear weatherstrip 30 is attached and fixed to the vehicle body 60. The rear weatherstrip 30 comes into elastic contact with the rear door glass 76 to fill and seal a gap between the rear door glass 76 and the vehicle body 60. Most of the front weatherstrip 10 has an elongated shape, and the front weatherstrip 10 comes into elastic contact with the front edge, the upper edge, and the rear edge of the front door glass 71. Similarly, the rear weatherstrip 30 comes into elastic contact with the front edge, the upper edge, and the rear edge of the rear door glass 76.

The front weatherstrip 10 and the rear weatherstrip 30 are disposed up to the proximity to the belt line BL but are not disposed in regions below the belt line BL. Therefore, as shown in FIG. 1B, the front door 70 has a region which is located below the proximity of the belt line BL and to which a front door weatherstrip 40 is attached, and the rear door 75 has a region which is located below the proximity of the belt line BL and to which a rear door weatherstrip 50 is attached.

The front door weatherstrip 40 includes: a front door weatherstrip body 41 which is elongated, is attached to the front door 70 on an outside in a vehicle width direction, and is sandwiched between the front door 70 and the vehicle body 60 on an inside in the vehicle width direction; and baseplates 42 and 43 which are integrally connected to respective ends of the front door weatherstrip body 41. The front door weatherstrip body 41 is an extrusion molded part made of a relatively soft rubber material and having a constant sectional surface (not shown). The baseplates 42 and 43 are also die molded parts made of a relatively soft rubber material and having a predetermined shape. The rubber material for the baseplates 42 and 43 may be either a foaming material or a non-foaming material, or may be a thermoplastic resin having rubber-like elasticity.

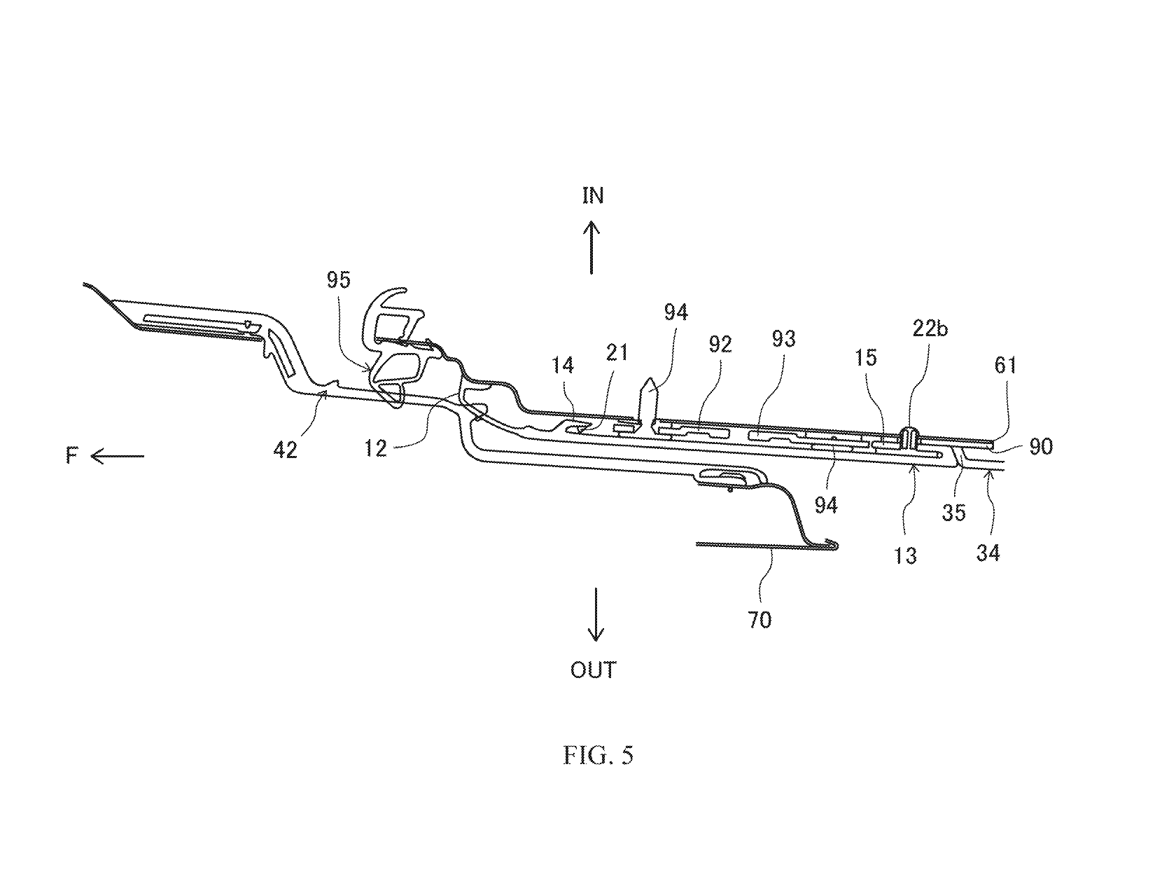

As shown in FIG. 5, the baseplate 42 having the predetermined shape is a member that comes into elastic contact with a baseplate 13 to achieve sealing when the front door 70 is closed, and the baseplate 42 is integrally connected to the front door weatherstrip body 41. The baseplate 43 having the predetermined shape is a member that comes into elastic contact with a baseplate 19 to achieve sealing when the front door 70 is closed, and the baseplate 43 is integrally connected to the front door weatherstrip body 41.

Similarly, the rear door weatherstrip 50 also includes: a rear door weatherstrip body 51 which is elongated; and baseplates 52 and 53 which are disposed at respective ends of the rear door weatherstrip body 51.

Moreover, most of a front vehicle-body-side weatherstrip 95 shown in FIGS. 1C and 5 is made from an extrusion molded part having a constant sectional surface, and the front vehicle-body-side weatherstrip 95 comes into contact with and seals the front door 70 when the front door 70 is closed. Moreover, most of a rear vehicle-body-side weatherstrip 98 shown in FIG. 1C is made from an extrusion molded part having a constant sectional surface, and the rear vehicle-body-side weatherstrip 98 comes into contact with and seals the rear door 75 when the rear door 75 is closed.

Moreover, the front vehicle-body-side weatherstrip 95 is attached to a peripheral edge of an opening formed in the vehicle body 60 and facing the front door 70 as shown in FIG. 1C. Moreover, similarly, the rear vehicle-body-side weatherstrip 98 is attached to a peripheral edge of an opening formed in the vehicle body 60 and facing the rear door 75 as shown in FIG. 1C.

To the vehicle body 60 (a B-pillar of the vehicle body 60) described later in FIG. 5, a B-pillar garnish 90 having a band plate shape is attached and fixed between the front weatherstrip 10 and the rear weatherstrip 30, a front part cover 81 having a triangular shape is attached and fixed at a location forward of the front weatherstrip 10, and a rear part cover 77 made of glass is installed at a location rearward of the rear weatherstrip 30. As shown in FIG. 1A, between a streamline-shaped ceiling of the vehicle body 60 and a set of the front door 70 and the rear door 75 provided in a continuous manner in the front/rear direction, the front part cover 81, the front door glass 71, the B-pillar garnish 90, the rear door glass 76, and the rear part cover 77 are smoothly consecutive in this order in the front/rear direction.

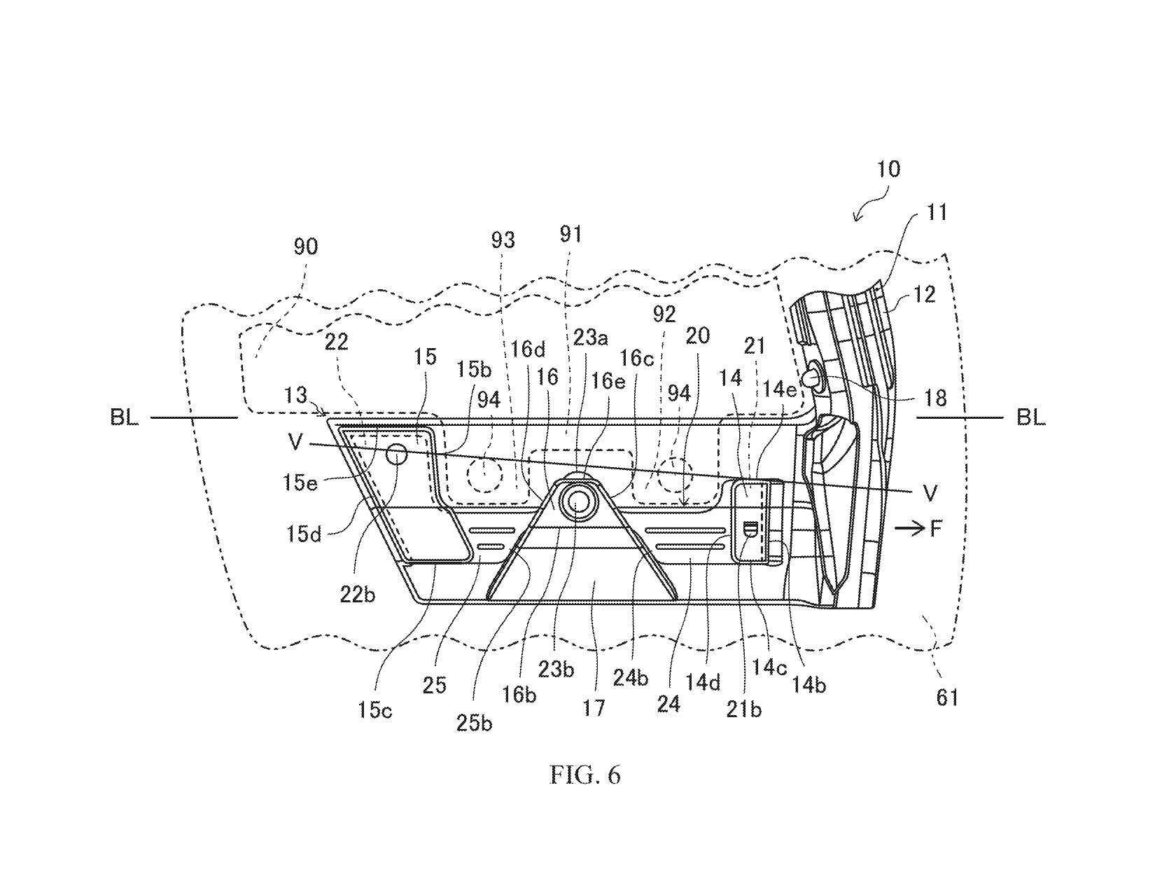

Further, when viewed from the outside in the vehicle width direction, the front part cover 81, the front door glass 71 at the upper position, the B-pillar garnish 90, the rear door glass 76 at the upper position, and the rear part cover 77 are disposed to be flush with each other, thereby appealing passengers who open the front door 70 and the rear door 75 to get into the vehicle 100 with stylish design. A positional relationship between a lower edge of the B-pillar garnish 90 and the front weatherstrip 10 will be described later with reference to FIG. 6.

The front weatherstrip 10 includes: a front weatherstrip body 11 which is elongated and is sandwiched between the front door glass 71 on the outside in the vehicle width direction and the vehicle body 60 on the inside in the vehicle width direction; and the baseplates 13 and 19 which are integrally connected to respective ends of the front weatherstrip body 11. The front weatherstrip body 11 is an extrusion molded part made of a relatively soft rubber material and having a constant sectional surface. The baseplates 13 and 19 are also die molded parts made of a relatively soft rubber material and having a predetermined shape. the front weatherstrip body 11 and the baseplates 13 and 19 may be either a foaming material or a non-foaming material, or may be a thermoplastic resin having rubber-like elasticity.

The baseplate 13 having the predetermined shape is in such a shape that the baseplate 13 is disposed along the lower edge and a front edge of the B-pillar garnish 90, and baseplate 13 is integrally connected to the front weatherstrip body 11. The baseplate 19 having the predetermined shape is in such a shape that the baseplate 19 is disposed along a rear edge and a lower edge of the front part cover 81, and the baseplate 19 is integrally connected to the front weatherstrip body 11. To a B-pillar 61 which is a pillar member of the vehicle body 60 and which is disposed between a front entrance/exit openable/closable by the front door 70 and a rear entrance/exit openable/closable by the rear door 75, the B-pillar garnish 90 as a decorative sheet is attached from the outside in the vehicle width direction. This makes the appearance of the B-pillar good.

Similarly, the rear weatherstrip 30 also includes: a rear weatherstrip body 31 which is elongated; and baseplates 34 and 37 having a predetermined shape and disposed at respective ends of the rear weatherstrip body 31. The baseplate 34 having the predetermined shape is in such a shape that the baseplate 34 is disposed along the lower edge and the rear edge of the B-pillar garnish 90, and baseplate 34 is integrally connected to the rear weatherstrip body 31. The baseplate 34 and the baseplate 13 described above are disposed adjacent, and continuous, to the lower edge of the B-pillar garnish 90 as shown in FIG. 1A. In the present embodiment, a front end of the baseplate 34 and a rear end of the baseplate 13 are arranged to match each other. As to the positional relationship between the baseplates 34 and 13, FIG. 5 described later is also to be referred.

These baseplates 13,19, 34, and 37 are attached and fixed to the vehicle body 60 with outsert boards and outsert clips which are described later. The following representatively describes the baseplate 13 of these baseplates.

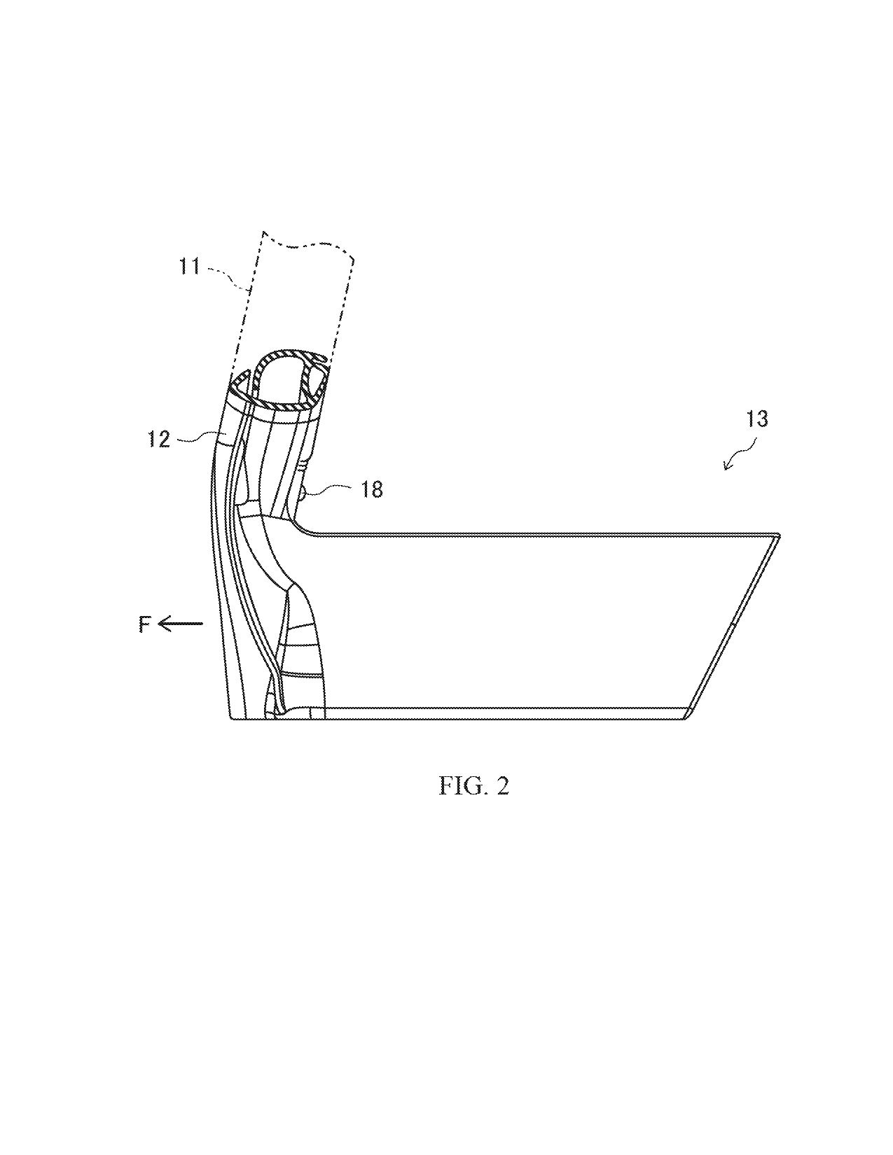

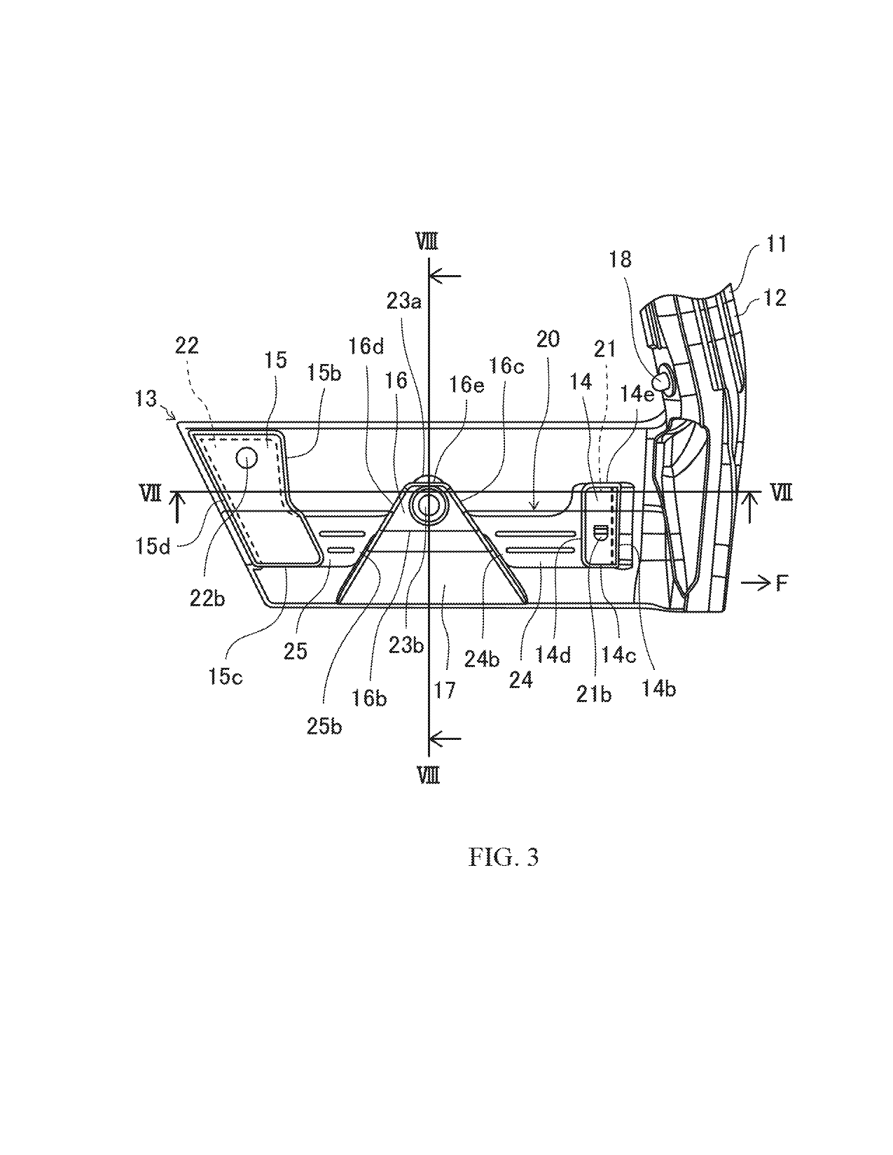

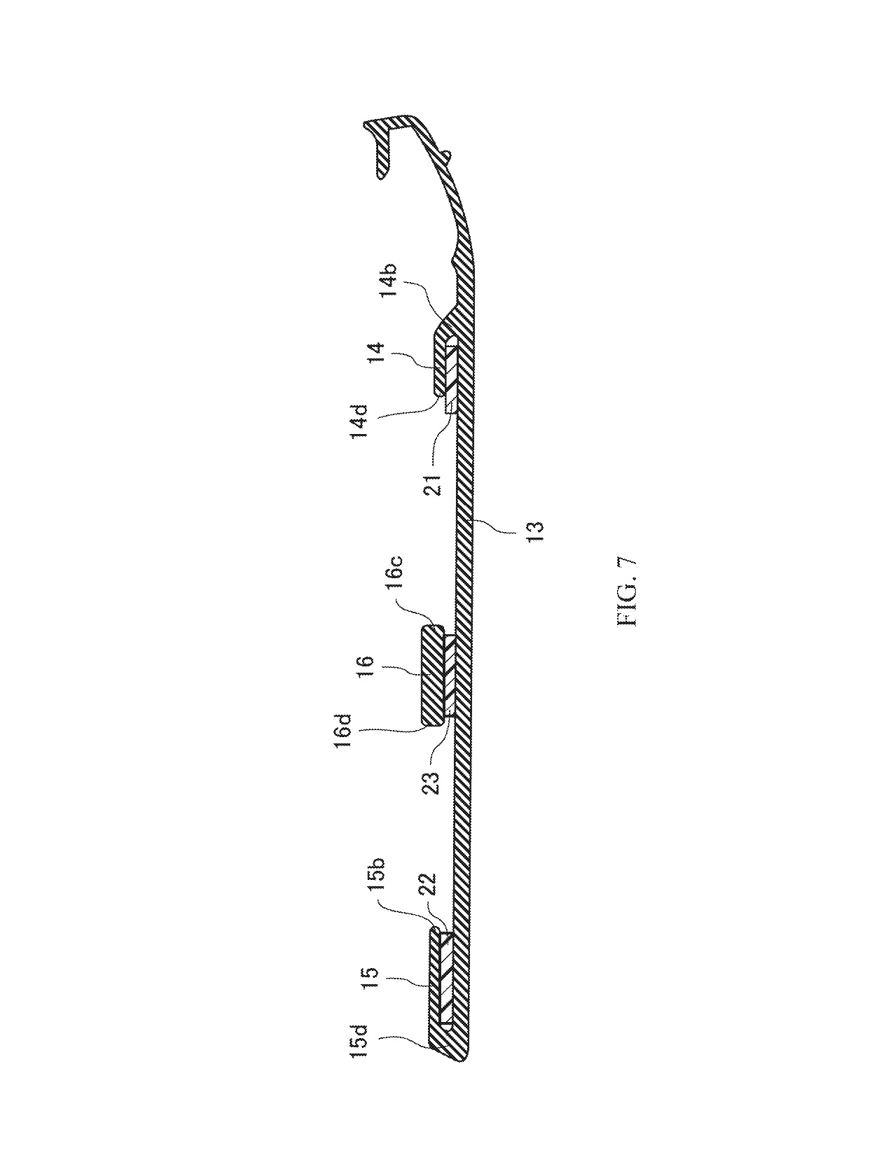

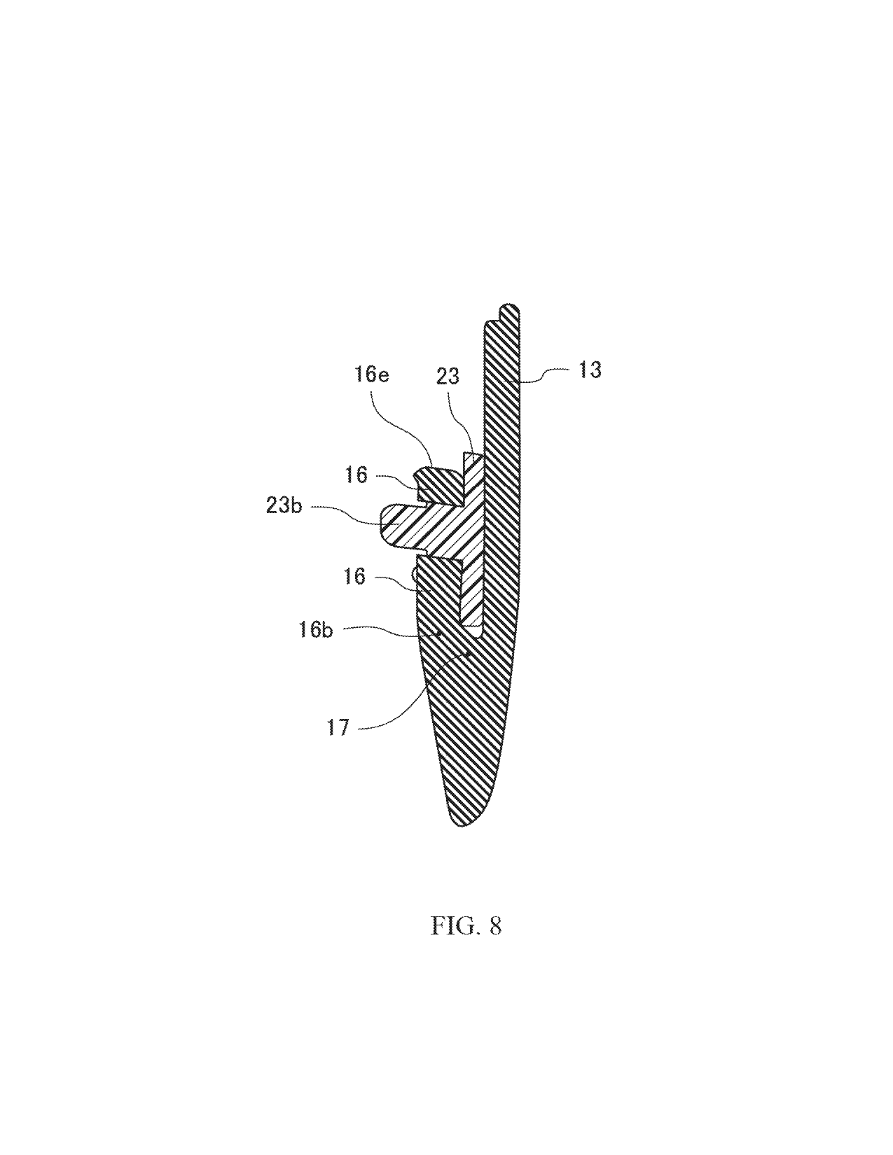

FIG. 2 is an outside view of an outside face of the baseplate of the embodiment. FIG. 3 is a backside view of a back face of the baseplate of the embodiment. FIG. 7 is a sectional view of the baseplate 13 taken along line VII-VII and viewed in the arrow direction of FIG. 3. FIG. 8 is a sectional view of the baseplate 13 taken along line VIII-VIII of FIG. 3. The baseplate 13 is a flat plate having a shape like a fin and extending in a direction different from a direction in which the weatherstrip body 11 is elongated, and as shown in FIGS. 1A, 7, and 8, the baseplate 13 has a smooth outside face. The baseplate 13 is attached and fixed to the B-pillar 61 (FIG. 1A) of the vehicle body 60 to take a position extending in the front/rear direction and the up/down direction with its outside face being on the outside in the vehicle width direction.

While the front door 70 is closed, the baseplate 13 is covered with the front door 70, but when the front door 70 is opened, the baseplate 13 is exposed outside in the vehicle width direction. The baseplate 13 having a fin shape is disposed with its fin length (longitudinal direction) aligned with the front/rear direction and its fin width aligned with the up/down direction. The baseplate 13 has a front end having a coupling part 12 integrally formed and extending to rise upward. Here, the coupling part 12 has a through hole formed at about the center thereof, and into the through hole, a clip 18, as a single piece, is inserted, and thereby, the coupling part 12 is attached and fixed to the B-piller 61 with the clip 18. The coupling part 12 extending in the up/down direction has an upper end integrally connected to the front weatherstrip body 11 described above. A sectional surface of the coupling part 12 orthogonal to the extension direction of the coupling part 12 gradually changes from a plate shape to a tubular shape from below to the upper clip 18 (not shown). Moreover, a sectional surface of an end of the front weatherstrip body 11 gradually changes to a shape, of which tubular shape is missing.

As shown in FIG. 3, the back face of the baseplate 13 has a plurality of return plates 14, 15, and 16 integrally formed therewith. These return plates 14, 15, and 16 are formed from the same material as the baseplate 13. In the present embodiment, the return plates 14, 16, and 15 are sequentially arranged from the front to the rear. The return plate 14 on a front side has: a front edge 14b integrally connected to the back face of the baseplate 13; and a rear edge 14d, a lower edge 14c, and an upper edge 14e which extend along the back face of the baseplate 13 with a predetermined gap from the baseplate 13. Thus, the return plate 14 extends parallel to the baseplate 13. Regarding the return plates 14, 15, and 16, see also FIGS. 7 and 8.

The return plate 15 on a rear side has: a rear edge 15d integrally connected to the back face of the baseplate 13; and a front edge 15b, a lower edge 15c, and an upper edge 15e which extend along the back face of the baseplate 13 with the predetermined gap from the baseplate 13. Thus, the return plate 15 also extends parallel to the baseplate 13. Note that the rear edge 15d obliquely extends from the lower front to the upper rear.

The return plate 16 at the center has: a lower edge 16b integrally connected to the back face of the baseplate 13; and a front edge 16c, a rear edge 16d, and an upper edge 16e which extend along the back face of the baseplate 13 with the predetermined gap from the baseplate 13. Thus, the return plate 16 also extends parallel to the baseplate 13. Note that the lower edge 16b is continuous with a thick plate part 17 having a trapezoidal shape with an upper short base and a lower long base. The thick plate part 17 has a larger thickness dimension than a region around the thick plate part 17. Regarding a thickness direction defined with respect to the baseplate 13, the thick plate part 17 has, at least at the lower edge 16b, such a thickness that the thick plate part 17 protrudes from the back face of the baseplate 13 by a total dimension of the thickness of the return plate 16 and the predetermined gap described above.

These return plates 14, 15, and 16 are respectively cantilever-supported by a front part, a rear part, and a lower part of the baseplate 13 such that these return plates 14, 15, and 16 protrude toward the center of the baseplate 13. Thus, the return plates 14, 15, and 16 house the outsert board 20 in the predetermined gap described above, thereby supporting the outsert board 20 described later such that the outsert board 20 does not fall.

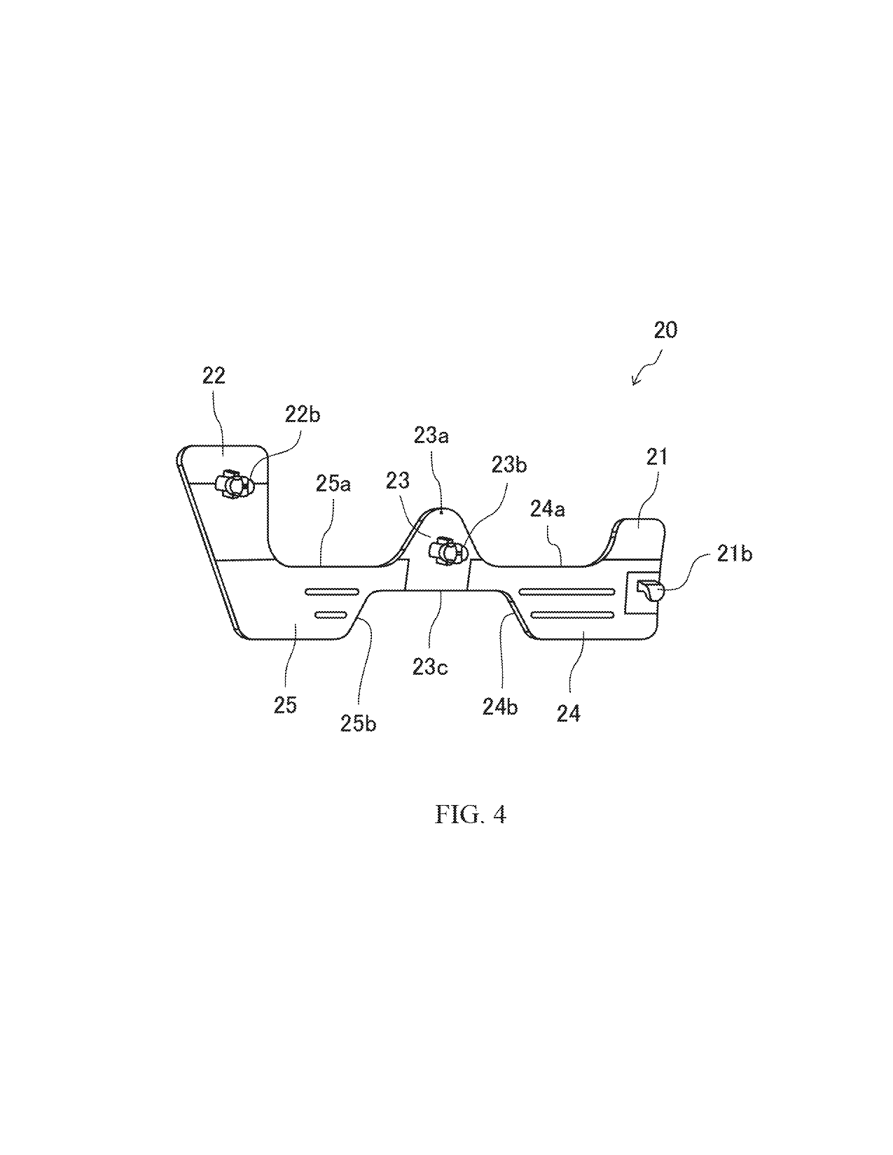

FIG. 4 is a view corresponding to FIG. 3 and showing a back face of the outsert board 20 taken out. The outsert board 20 is configured to be inserted between the back surface of the baseplate 13 and the return plates 14, 15, and 16. Note that FIG. 4 shows the outsert board 20 seen from the rear, slightly obliquely above so that the rising height of the outsert clip described later is apparent. The outsert board 20 is made of a resin material harder than the baseplate 13 and serves as a core material supporting the baseplate 13. The outsert board 20 includes a first end part 21, a second end part 22, a center part 23, a projection 21b, and outsert clips 22b and 23b. These components are molded integrally. As shown in FIG. 2, when seen from an outside, the outsert board 20 is completely covered with the baseplate 13. Therefore, also when the front door 70 is opened, the outsert board 20 is not at all exposed to outside the vehicle body 60.

As shown in FIGS. 3, 7, and 8, the first end part 21 of the outsert board 20 is inserted between the baseplate 13 and the return plate 14 on the front side and is restricted from moving forward. Moreover, the second end part 22 is inserted between the baseplate 13 and the return plate 15 on the rear side and is restricted from moving rearward. Further, the center part 23 is inserted between the baseplate 13 and the return plate 16 on the lower side and is restricted from moving downward. As described above, the outsert board 20 is held on the back face of the baseplate 13 with the plurality of return plates 14, 15, and 16.

The projection 21b is disposed to rise on a back face of the first end part 21. The projection 21b is fitted into a through hole formed in the return plate 14. In the present embodiment, the rising height of the projection 21b is greater than the thickness of the return plate 14, the projection 21b has a tip end having a downward hook shape, and the projection 21b penetrates through the return plate 14 to engage with the through hole. This engagement keeps the first end part 21 in contact with the return plate 14 and makes it difficult for the first end part 21 to be separated from the return plate 14.

The outsert clip 22b is disposed to rise on a back face of the second end part 22. The outsert clip 22b is fitted in a through hole formed in the return plate 15 such that a tip end of the outsert clip 22b protrudes from the return plate 15. The outsert clip 23b is disposed to rise on a back face of the center part 23. The outsert clip 23b is fitted in a through hole formed in the return plate 16 such that a tip end of the outsert clip 23b protrudes from the return plate 16.

The center part 23 of the outsert board 20 has a cutoff 23c. A lower portion of the center part 23 is cut off due to the cutoff 23c. In the present embodiment, the cutoff 23c has a trapezoidal shape. The trapezoidal shape has an upper short base and a lower long base.

With reference to FIG. 4, the outsert board 20 has a first end region 24 formed between the first end part 21 and the center part 23 and having an avoidance part 24a having a cutoff shape. The avoidance part will be described later with reference to FIGS. 5 and 6. An upper portion of the first end region 24 is cut off due to the avoidance part 24a. Thus, the first end part 21 and the center part 23 protrude from the first end region 24 relatively upward. This protruding portion of the center part 23 forms a ridge part 23a having a triangular shape. The first end region 24 has a rear edge 24b extending downward to be continuous with the triangular shape of the ridge part 23a. Moreover, the rear edge 24b defines a front side of the cutoff 23c having the trapezoidal shape.

Moreover, the outsert board 20 has a second end region 25 formed between the second end part 22 and the center part 23 and having an avoidance part 25a having a cutoff shape. An upper portion of the second end region 25 is cut off due to the avoidance part 25a. Thus, the second end part 22 and the center part 23 protrude from the second end region 25 relatively upward. The second end region 25 has a front edge 25b extending downward to be continuous with the triangular shape of the ridge part 23a. Moreover, the front edge 25b defines the rear side of the cutoff 23c having the trapezoidal shape.

The cutoff 23c having the trapezoidal shape has a shape matching the shape of the thick plate part 17 (FIG. 3) and is fitted in the thick plate part 17. The edges 24b and 25b are in line-contact with, and are supported by, the thick plate part 17.

FIG. 5 is a sectional view illustrating an attached and fixed state of the present embodiment and shows a sectional view of the baseplate and a vehicle-body-side member along line V-V of FIG. 6 described later. The outsert clip 22b penetrating through the return plate 15 is directed inward (IN) in the vehicle width direction, and a tip end portion of the outsert clip 22b is inserted into and fixed to a clip hole formed in the vehicle body 60. The outsert clip 23b (not shown in FIG. 5) is also inserted into and fixed to a clip hole formed in the vehicle body 60 (specifically, the B-pillar 61). The baseplate 13 is reliably attached and fixed to the B-pillar 61 of the vehicle body 60 with the plurality of outsert clips 22b and 23b.

In FIG. 5, outside (OUT) the baseplate 13 in the vehicle width direction, the front door 70 in the closed position is located, and the baseplate 13 is covered with the front door 70. When the front door 70 is opened outward (OUT) in the vehicle width direction, the outside face of the baseplate 13 is exposed. The outside face of the baseplate 13 is simple and smooth face as shown in FIG. 2 and has no unevenness or projections. In FIG. 5, a lower edge part of the B-pillar garnish 90 is shown in a sectional view. Moreover, a lower outside face (outer face in the vehicle width direction) of the B-pillar garnish 90 is provided with the baseplate 34 of the rear weatherstrip 30. The baseplate 34 has a step 35 substantially the same height as a thickness dimension of the baseplate 13. Thus, the outside face of the baseplate 34 and the outside face of the baseplate 13 are flush with each other. In a variation (not shown), the baseplate 13 and the baseplate 34 may be integrally molded in advance into a single component, and the single component may be attached to the B-pillar 61, instead of attaching, to the B-pillar 61, the baseplate 13 and the baseplate 34 aligned to abut each other in advance.

FIG. 6 is a backside view of a positional relationship between the front weatherstrip 10 of the present embodiment attached and fixed to the B-pillar 61 of the vehicle body 60 and the B-pillar garnish 90, viewed from the inside to the outside in the vehicle width direction (in a direction opposite to the direction in FIGS. 1A and 2). The B-pillar garnish 90 has a lower outside face which is set back with respect to an upper outside face thereof, where the belt line BL extending in the front/rear direction is a border between lower and upper sides. The lower edge part 91 of the B-pillar garnish with the belt line BL as the border is covered with the baseplate 13 from outside in the vehicle width direction. The lower edge part 91 of the B-pillar garnish 90 includes two fixing plate parts 92 and 93 disposed with a space therebetween in the front/rear direction and protruding downward. Fixing clips 94 penetrate the fixing plate parts 92 and 93 on a one-to-one basis from outside in the vehicle width direction, and the fixing clips 94 are inserted and fixed in clip holes formed in the B-pillar 61 of the vehicle body 60.

The lower edge part 91 of the B-pillar garnish including the fixing plate parts 92 and 93 is covered with the baseplate 13 from outside in the vehicle width direction. Thus, the baseplate 13 and the B-pillar garnish 90 above the belt line BL appear to be naturally continuous, and also when the front door 70 is opened and the baseplate 13 is exposed, the appearance is good. Here, the fixing plate part 92 is housed in the avoidance part 24a of the outsert board 20. Moreover, the fixing plate part 93 is also housed in the avoidance part 25a of the outsert board 20. Thus, the lower edge part 91 of the B-pillar garnish and the outsert board 20 do not interfere with each other, and a fixing structure of the B-pillar garnish 90 and an attachment and fixation structure of the baseplate 13 are collected in a compact manner, and the thickness thereof can be further reduced.

The front weatherstrip 10 of the present embodiment includes: the front weatherstrip body 11 configured to be disposed along the vehicle body 60, the front weatherstrip body 11 being the vehicle-body-side member, the vehicle-body-side member being a member on a vehicle-body side when viewed from the front weatherstrip 10; the baseplate 13 integrally connected to the front weatherstrip body 11; the return plate 15 having a part integrally connected to the back face of the baseplate 13 and a remaining part extending along the back face, the return plate 15 being completely covered with the baseplate 13 when viewed from the outside face side of the baseplate 13; the outsert board 20 which is a board formed from a material harder than the baseplate 13, the outsert board 20 being inserted between the back face of the baseplate 13 and the return plate 15 to be completely covered with the baseplate 13 when viewed from the outside face side of the baseplate 13; and the outsert clip 22b disposed to rise on the outsert board 20 and penetrating through a through hole formed in the return plate 15 to be fitted in a clip hole formed in the B-pillar 61 of the vehicle body 60. In the present embodiment, the outsert board 20, which is a structure for attaching and fixing the baseplate 13 to the B-pillar 61 of the vehicle body 60, is completely hidden and cannot be seen when viewed from the outside face side of the baseplate 13 as shown in FIG. 2. This can make the appearance of the front weatherstrip 10 attached and fixed to the B-pillar 61 of the vehicle body 60 good.

Moreover, as shown in FIGS. 3, 4, 7, and 8, the front weatherstrip 10 of the present embodiment includes the plurality of return plates 14, 15, and 16. Each of the return plates 14, 15, and 16 has a part integrally connected an edge of the baseplate 13, and a remaining part protruding toward the center of the baseplate 13, to form a zone for housing the outsert board 20. Thus, the outsert board 20 is housed with three sides embraced by the plurality of return plates 14, 15, and 16.

Moreover, as shown in FIG. 1, the baseplate 13 of the present embodiment has a fin shape and is attached and fixed to the B-pillar 61 (vehicle-body-side member) of the vehicle body 60 to take a position of extending in the up/down direction such that a fin width of the baseplate 13 is in the up/down direction. As shown in FIG. 3, the return plate 16 has: the lower edge 16b integrally connected to the back face of the baseplate 13; and the upper edge 16e having a through hole formed for the outsert clip 23b. Thus, the baseplate 13 is attached and fixed to left and right side faces of the B-pillar 61 of the vehicle body 60. Thus, the outsert board 20 is suppressed from climbing over the return plate 16 and falling down.

Moreover, the lower edge 16b of the present embodiment is continuous with the thick plate part 17 having a greater thickness than the upper edge 16e. The outsert board 20 has the cutoff 23c (FIG. 4) for receiving the thick plate part 17. This prevents the position of the outsert board 20 held by the return plate 16 from being shifted.

Moreover, the thick plate part 17 of the present embodiment has a trapezoidal shape with a relatively short upper base and a relatively long lower base as shown in FIG. 3. As shown in FIG. 4, the cutoff 23c has a shape corresponding to the thick plate part 17 having the trapezoidal shape and is fitted in the thick plate part 17 from above as shown in FIG. 3. Thus, the outsert board 20 is stably held by the thick plate part 17.

Moreover, the baseplate 13 of the present embodiment has a fin shape and has a fin length direction (longitudinal direction) and a fin width direction. The outsert board 20 extends in the fin length direction of the baseplate 13. The plurality of the return plates 14, 15, and 16 are disposed with a space therebetween in the fin length direction of the baseplate 13. This can impart stiffness to the stator core 13 having the fin shape.

Moreover, the front weatherstrip 10 of the present embodiment further includes: the projection 21b disposed on the outsert board 20; and a through hole (with no bottom) which is formed in the return plate 14 and in which the projection 21b is fitted. Thus, the outsert board 20 is reliably attached to the baseplate 13. A variation (not shown) may have, in place of the through hole, a bottomed hole into which the projection 21b is fitted.

Moreover, the baseplate 13 of the present embodiment covers and hides the fixing clip 94 with which part of a decorative sheet such as the B-pillar garnish 90 is attached to the B-pillar 61 (vehicle-body-side member) of the vehicle body 60. The plurality of return plates 14, 15, and 16 are disposed while avoiding the fixing clip 94, and the outsert board 20 has the avoidance parts 24a and 25a having a cutoff shape to avoid the fixing clip 94. Thus, a fixing structure of the B-pillar garnish 90 and an attachment and fixation structure of the baseplate 13 are collected in a compact manner, and the thickness thereof can be further reduced.

The embodiment of the present disclosure has been described with reference to the drawings, but the present disclosure is not limited to the examples shown in the drawings. The embodiment shown in the drawings may be variously modified or changed within the scope of the present disclosure or within the scope of the equivalent thereof.

The present disclosure is applicable to weatherstrips such as a front weatherstrip and a rear weatherstrip. Further, the present disclosure is applicable to the fin-shaped die molded part to be attached to a vehicle body as the embodiment described above, and is also applicable to any fin-shaped die molded part to be applied to a door such as a front door or a rear door. Moreover, the present disclosure is applicable also to the fin-shaped die molded part of the door weatherstrip of a type as described in Patent Literature 1.

The present disclosure is industrially advantageously applied to vehicles.

What is claimed is:

1. A weatherstrip comprising:
a weatherstrip body configured to be disposed along a vehicle-body-side member of a vehicle;
a baseplate integrally connected to the weatherstrip body;
a return plate integrally connected to the baseplate and disposed on a back face of the baseplate;
an outsert board which is a board formed from a material harder than the baseplate, the outsert board being inserted between the back face and the return plate to be covered with the baseplate when viewed from an outside face side of the baseplate; and
an outsert clip disposed to rise on the outsert board, penetrating through a hole formed in the return plate, and configured to be fitted in a clip hole formed in the vehicle-body-side member.

2. The weatherstrip of claim 1, comprising a plurality of the return plates, wherein
the plurality of return plates each have a part integrally connected to an edge of the baseplate and a remaining part protruding toward a center of the baseplate to form a zone for housing the outsert board.

3. The weatherstrip of claim 1, wherein
the return plate has a lower edge part integrally connected to the back face and an upper edge part having the through hole.

4. The weatherstrip of claim 3, wherein
the lower edge part is continuous with a thick plate part having a greater thickness than the upper edge part, and
the outsert board has a cutoff for receiving the thick plate part.

5. The weatherstrip of claim 4, wherein
the thick plate part has a trapezoidal shape with a relatively short upper base and a relatively long lower base, and
the cutoff has a shape corresponding to the trapezoidal shape and is fitted in the thick plate part.

6. The weatherstrip of claim 1, wherein
the baseplate has a longitudinal direction and a width direction,
the outsert board extends along the longitudinal direction of the baseplate, and
a plurality of the return plates disposed with a space therebetween in the longitudinal direction of the baseplate.

7. The weatherstrip of claim 1, further comprising:
a projection provided on the outsert board; and
a hole which is formed in the return plate and in which the projection is fitted.

8. The weatherstrip of claim 6, wherein
the baseplate covers a fixing clip with which a decorative sheet is attached and fixed to the vehicle-body-side member,
the plurality of return plates are disposed while avoiding the fixing clip, and
the outsert board has an avoidance part for avoiding the fixing clip.
